(19) United States
(12) Patent Application Publication
(10) Pub. No.: US 2004/0095399 A1
(43) Pub. Date: May 20, 2004

(54) Method and device for interpretation of an observed object

(76) Inventors: Adi Anani, Umea (SE); Haibo Li, Umea (SE)

Correspondence Address: BURNS DOANE SWECKER & MATHIS L L P, POST OFFICE BOX 1404, ALEXANDRIA, VA, 22313-1404, US

(21) Appl. No.: 10/451,888

(22) PCT Filed: Dec. 12, 2001
(86) PCT No.: PCT/SE01/02745

(30) Foreign Application Priority Data
Dec. 28, 2000 (ES) SE 0004873-6

(51) Int. Cl. G09G 5/00

(52) U.S. Cl. 345/863; 345/700

(57) ABSTRACT

The present invention concerns a method and a system for the interpretation of an object observed by a person about which the person desires information. The method entails the production of a digital image of the person's field of view, whereby the person's pattern of movement is detected for identifying a request for the interpretation and determination of the position in the image of the object for the request, an object is located in the image by means for positional information, the located object is identified, the identified object is interpreted and the result of the interpretation is presented to the person. The system comprises a portable camera unit (1) directed to reproduce an image of the field of view of a person carrying the system, whereby a means for providing positional information (3) is arranged to interpret the persons request for interpretation and identify the position in the image where the object of the request is found, that a means for locating an object (2) is arranged to locate the object in the image, a means for identifying an object (4) is arranged to identify the located object, a means for interpreting (5) is arranged to provide information associated with the identified object and a means for presentation (7) is arranged to present the results of the interpretation to the person carrying the system.

The present invention concerns a method and a system for interpreting an observed object according to the preamble to the attached independent claims.

It is known that we cannot always understand or interpret what we see. This may be a wild flower that we do not recognize or that we want more information on, a word in a text that we do not understand, an unknown word or a word in a foreign language, an unknown alphabet, etc. The list of situations can go on and on.

Regarding e.g. foreign words, translating words, this can be achieved with a computerized pen reader that is moved across the word to be read, converts it to a text file (OCR) and after consulting a digital dictionary the translation can be displayed on a screen on the pen. This is a satisfactory solution in many cases but not all. The person needing the help may not always want to make it evident to others. The pen can not be used for interpreting three-dimensional objects, or tensional objects other than text. There are also restrictions to how large or extensive an object may be if it is to be read.

One object of the present invention is to alleviate or even completely overcome the failings beeing present in known techniques.

It is a further object of the present invention to achieve an active system that identifies an occasion when interpretation is required and that provides the user with the necessary interpretation without any special active initiative.

These objectives can be attained with the employment of the aforesaid system, which exhibits the technical features defined in the characterising part of the following independent claims.

Other technical features and advantages with the invention and its embodiments will be evident in the dependent patent claims and the following detailed descriptions of further embodiments.

Special expressions and designations of component parts have been used in the detailed description for reasons of clarity of the embodiments. These expressions and designations shall not be interpreted as limitations for the scope of protection of the invention but as examples within it.

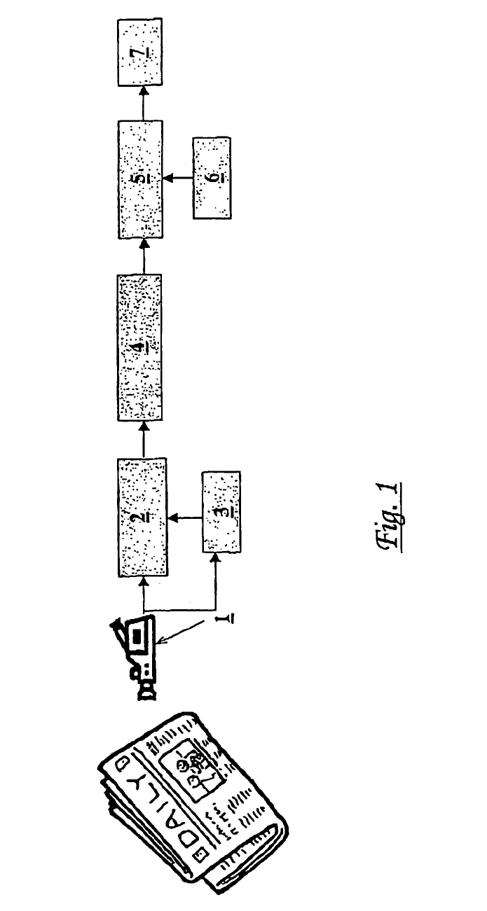

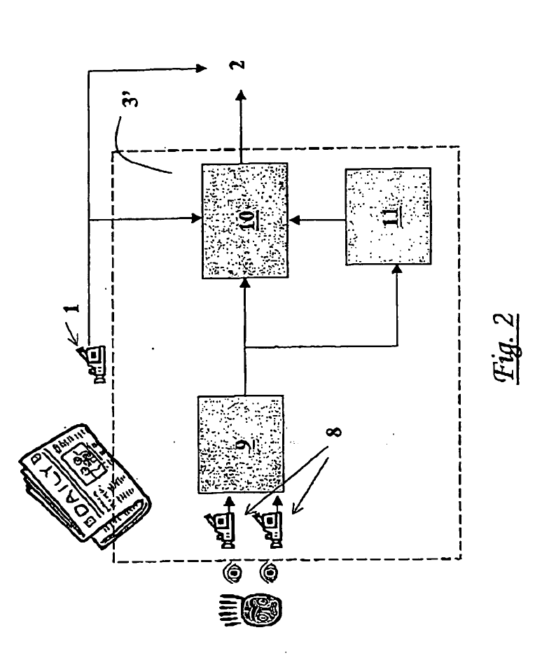

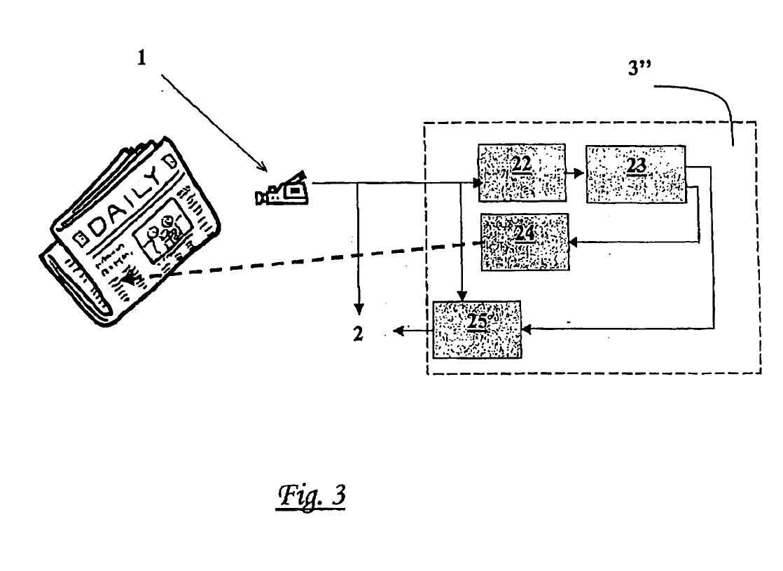

FIG. 1 illustrates, in a schematic way, a system according to a first embodiment of the present invention, FIG. 2 illustrates, in a schematic way, an embodiment of a support system for the embodiment according to FIG. 1 and FIG. 3 illustrates, in a schematic way, an alternative support system for the embodiment according to FIG. 1.

The present invention concerns, in a summarized way, a method and a system for identifying if the carrier/user/person wants to get information n an bject, placed in the field of vision of the carrier/user/person, by visual interpretation of the carrier/user/person's movements/gestures using technics for picture analysing. And further to locate, identify and supply information on the identified object.

A system according to the present invention comprises:

A portable camera unit, which is pointed in the direction of viewing of the person carrying the system.

A means for locating an object, the means beeing arranged to locate the object to which the user is currently paying attention.

A means for giving information of position, the means beeing arranged to help the means for locating the object to define a segment in the image from the camera, the segment containing the object.

A means for identifying the object, the means beeing arranged to identify the located object.

A means for interpreting is arranged to retrieve information concerning the identified object from an available database.

A means for presentation, the means beeing arranged to present, to the person carrying the system the information that has been found and beeing associated to the object in question.

In a first embodiment, the camera unit can include a camera 1 arranged on a carrier for providing moving images or still images at short intervals covering at least a significant portion of what the person has in view. Camera 1 can well be arranged on a pair of spectacles or similar in order to follow the head movement of the carrier.

Images from the camera 1 are conveyed to the object locating means 2. The object locating means 2 receives information from the positioning means 3 concerning the position of the object in the image conveyed from the camera. Hereby, the image supplied by the camera 1 can be limited so that only one segment of the image is provided for further processing.

When the object in question is located, in this case a word from a column of print in a newspaper, an image segment containing the object is conveyed to the identifying means 4. The object is identified using image analysis. In the present example, the object is identified as word writt n in block letters.

The segment of the image comprising the object is forwarded to the interpreting means 5 with the information on what the object is, in this case text. Based on this information the contact to a relevant database 6, for interpreting f the object, is initiated. In the present example a so-called OCR program is first initiated to convert the image of the text into a text string. This test string is passed on to a dictionary for finding the meaning of the word.

The information found by the inter means 5 is subsequently presented in a suitable manner to the user through the presentation means 7. This presentation can be made through images, sound, tactile transfer or a combination of these.

Images can be presented e.g. by projection onto a pair of spectacles or directly on the retina of the user/carrier.

Sound can e.g. be transfered through loudspeakers in or in direct conjunction with the user's/carrier's ear. For a person with impaired hearing, the sound transfer can be integrated into an existing hearing aid, a hearing apparatus for example.

Tactile transfer can be achieved in a, for a skilled person, known manner, by Braille or something similar.

The means for providing positional information 3 can, in a first embodiment, by sensing the eyes of the user, calculate the direction of view and by using known geometrical relationships, the position of an object being observed by the carrier can be determined. The direction then specifies an area within which the carrier's attention is concentrated. For observing a small object at a long distance, a higher resolution will consequently be required than for observing a relatively large object at a short distance.

A high resolution is also relatively costly. Such a means for sensing the carrier's direction of viewing in practice requires further support for determining which of the objects within the accordingly defined image segment that the carrier is observing.

To determine whether such further support is required, a decision parameter called a certainty parameter can be introduced. If the defined image segment exhibits only one object e.g. a word, the certainty parameter will be high. If the image segment contains two or more objects, the value of the certainty parameter will be reduced correspondingly.

FIG. 1 and FIG. 2, show how positional information to the means for locating an object 2 can be achieved. A means for providing positional information 3′ comprises a means for sensing eye direction 9, the object of which is to detect and determine the direction of vision from images of the carrier's eyes. Two cameras 8 for this purpose are directed towards the carrier's eyes, one camera for each eye. The cameras 8 record moving video images or digital still images at short intervals. The direction of view is calculated by sensing the rientation and spatial position of each eye, usually with triangulation, which is a well-known mathematical method.

Information on the detected direction of view is provided by the means for sensing eye direction 9 partly to a means for analysing documents 10 and partly to a means for analysing vision 11.

The object of this means for analysing documents 10 is to assist with the identification of the correct word within the image segment given by the direction of view. Consequently, demands on the resolution of the cameras and of the eye direction sensing means 9 can be reduced.

The document analysing means 10 analyses all the words within the area defined by the eye direction sensing means 9 in order to come across the word that the user will most probably require interpreting. This coming across is based on an analysis of e.g. words that are common and simple, words that have been handled previously, words that have been newly interpreted, etc. The means for analysing documents need not be active either if the certainty parameter exceeds a certain value, e.g. corresponding to two objects or two words.

The word that is initially selected can be marked, e.g. by highlighting or marking on the user's spectacles, or similar, whereby a visual feedback can be obtained. Hereby, the carrier is informed of whether the system has performed a correct analysis and in a correct way choosen the object which the carrier has shown interest in. The user can for example respond with distinct/certain eye movements, which can be registered by the cameras 8 of the eye direction sensing means 9, and interpreted by the means for analysing vision 11. Based on the information from the means for analysing vision 11, the means for analysing a document 10 can consequently determine whether a) the positional information is to be sent to the means for locating an object, b) new corrected suggestions for an object are to be made or c) attempts to find the correct object an to cease, whereby the user's gaze moves on without waiting for interpretation.

The means for analysing vision 11 is intended to interpret eye movement, to understand the semantic meaning of an eye movement or eye gesture. At least three patterns of movement must be identified and interpreted, namely concentrate, change and continue.

With reference to the reading example, concentrate means that the user stops at a certain word and views it. Change means that the user means another word close to the word that was guessed initially. Continue just means that the user wants to continue reading and d es not require any assistance at the moment. The instructions interpreted by the vision analysing means 11 are conveyed to the document analysing means 10.

To automate interpretation, a time limit may well be specified, whereby, if the carrier's gaze should stop on an object for longer than the specified time, an automatic position fixing and interpretation of the object can be initiated.

The positioning means 3 can, in a second embodiment 3″ as schematically illustrated in FIG. 3, use a cursor controlled by the user that is visualised in the area being observed by the user/carrier and can be used for marking an object or an area around the object.

Referring to FIG. 1 and FIG. 3, positional information can, in another embodiment, be created and conveyed to the object locating means 2 in the following way: Camera 1, which supplies images to the object locating means 2, is also connected to the for positioning 3″. This comprises in a hand locating means 22, a gesture interpreting means 23, a cursor generating and controlling unit 24 and a cursor position sensor 25.

The hand locating means 22 locates at least one hand in the image and subsequently sends the image segments showing the hand to the gesture interpreting means 23. Hereby, the size of the image needed for processing can be reduced.

The function of the gesture interpreting means 23 comprises understanding the semantic of a hand movement or a gesture. This can also apply to individual fingers. Examples of what can be achieved through gestures are moving a cursor, requesting a copy, activating an interpretation, etc. Consequently, a hand movement is used to control a number of different activities.

From the gesture interpreting means 23 instructions, according to the present embodiment, rendered from gestures, are transmitted to the cursor generating and controlling unit 24 and to the cursor position sensor 25.

The object of the cursor generatin and controlling unit 24 is to achieve a cursor visually perceptible to the user/carrier, either a cursor on the document, e.g. with an active laser, or a overlapping cursor on the user's spectacles to attain the same result.

In the exhibited example with laser cursor, the cursor position sensor 25 can be used to locate the position of the cursor in the image created by the camera 1. To assist it, there is the camera 1 image of the document with cursor or from the camera 1 image in combination with information from the means for interpreting a gesture 23.

In the alternative with overlapping cursor on spectacles, the information is sent fr m the cursor generating and controlling unit 24, e.g. the cursor coordinates, partly directly t the cursor sensor 25 and partly to the spectacles. Spectacles can also be used for other feedback t the carrier.

If a cursor, e.g. a point of light generated by a laser beam, is directed towards the newspaper, see FIG. 3, its position in the image can consequently be determined by interpreting the camera's image signal and the user/carrier can perform a certain pattern of finger movements to move the laser beam cursor across the page of the newspaper. In such a way, the user/carrier can carry out precision activities in the observed and reproduced area, e.g. manoeuvre the cursor to the beginning of a word in the text, activate the marking, move the cursor over the word, deactivate the marking and initiate interpreting.

The portable camera 1 can exhibit one or more lenses. Several interacting cameras can be arranged at one or more positions on the carrier. The camera/cameras can more generally reproduce the area around the card or it/they can provide images that show a more defined area towards which the carrier is currently looking. The latter can be achieved with e.g. a camera carried so that it follows head movement such as when arranged on a pair of spectable frames. A camera that can provide moving images is preferable, so-called video.

To supply a wide range of objects, with regard to extent and size, the camera 1 can include several cameras with varying resolution, so that e.g. a high resolution camera can be used far interpreting small objects while an object of larger dimensions, e.g. a house, can use a camera with normal or low resolution, and still making image analysis meaningful.

If the camera unit contains the users/carrier's entire field of vision, the object will be situated in the image generated by the camera 1.

One or more databases can be available. The system can, for example, by use of communication solutions be connected to a large number of independent databases, irrespective of the physical distance to these. Wireless communication can preferably be used, at least the first distance between the user/carrier and a stationary communication unit.

1. Method of interpreting an object being observed by a person that the person desires information on, entailing the creation of a digital image of the person's field of vision, characterised in that the person's pattern of movement is detected for identifying a request for the interpretation and determination of the position in an image of the object of the request, that an object is located in the image by means for positional information, that the located object is identified, that the identified object is interpreted and that the result from the interpretation is presented to the person.

2. Method according to claim 1, characterised in that when detecting the person's pattern of movement for identifying the request for the interpretation and/or determination of the position in the image of the object of the request, the person's eye movement is registered.

3. Method according to claims 1-2, characterised in that when detecting the person's pattern of movement for identifying the request for the interpretation and/or determination of the position in the image of the object of the request, the person's hand movement or gestures are registered.

4. Method in accordance with claims 1-3, characterised in that a segment containing the object is limited in the image and transfered to object identification.

5. System for interpretation of an object observed by a person that the person desired information on, comprising a portable camera unit (1) directed to reproduce an image of the field of view of a person carrying the system, characterised in that a means for providing positional information (3) is arranged to interpret the persons request for interpretation and identify the position in the image where the object of the request is found, that a means for locating an object (2) is arranged to locate the object in the image, that a means for identifying an object (4) is arranged to identify the located object, that a means for interpreting (5) is arranged to provide information associated with the identified object and that a means for presentation (7) is arranged to present the results of the interpretation to the person carrying the system.

6. System according to claim 5, characterised in that the means for providing positional information (3′) comprises a means for sensing eye direction (8, 9) that detects the direction of view of the carrying person and thereby a segment of the image produced in the camera (1).

7. System according to claim 6, characterised in that a means for analysing an image (10) is arranged for analysis of the object found in the segment defin d by the means for sensing eye direction (8, 9) and that a means for analysing vision (11) is arranged to understand the semantic meaning of an eye movement or eye gesture by interpreting eye movements.

8. System according to claim 5, characterised in that the means for providing positional information (3′) comprises a means for locating a hand (22) for recognising a or part of a hand, a means for interpreting a gesture (23) for interpreting the semantic meaning of a hand movement or gesture, a cursor generating and controlling unit (24) for controlling the cursor that is visually perceived by the carrying person and a cursor position sensor (25) to detect the position of the cursor in the camera (1) image.

9. System according to claim 8, characterised in the cursor visually perceived by the carrier is a cursor in the field of vision, primarily a point of light or an illuminated area formed by a laser beam.

10. System according to claim 8, characterised in that the cursor visually perceived by the carrier is an overlapping cursor formed on the carrier's spectacles.
